(19) United States
(12) Patent Application Publication
(10) Pub. No.: US 2019/0050435 A1
(43) Pub. Date: Feb. 14, 2019

(54) Object data association index system and methods for the construction and applications thereof

(71) Applicant: Lidong Qu, Beijing (CN)

(72) Inventor: Lidong Qu, Beijing (CN)

(21) Appl. No.: 15/526,814

(22) PCT Filed: Mar. 16, 2017
(86) PCT No.: PCT/CN2017/076908

§ 371 Date: May 15, 2017

(30) Foreign Application Priority Data
May 6, 2016 (CN) 201610296964.4

(51) Int. Cl. G06F 17/30; G06K 19/06; G06K 19/07; G06K 7/14

(52) U.S. Cl. CPC G06F 17/30321; G06F 17/30607; G06K 19/06028; G06K 7/1417; G06K 19/0723; G06K 7/1413; G06K 19/06037

(57) ABSTRACT

The present disclosure relates to an object data association index system and methods for constructing and applying the system in the field of computer technology. The disclosed system includes a plurality of objects, an object small data server, and an object index data server. The object small data server stores the object small data. The object index data server obtains an object ID and an operation ID from the object small data server, generates and stores the object index data, thereby constructing the object ID and the associated operation ID and the object data association index between the small data generated by the operation. Different data systems can thus conveniently exchange and sharing data, which lowers utilization threshold for big data and assures data association between different data systems, allows analysis of data associated model, which ultimately enhances data value.

### BACKGROUND OF THE INVENTION

This invention relates to the field of computer information technologies, in particular to the field of computer network technologies, and specifically, to an object data association index system and methods for the construction and applications of such system.

Big data, or huge amounts of information, refers to an amount of data in a huge scale that cannot be captured, managed, processed, and organized using current mainstream software tools within a reasonable time to help enterprises to make proactive business decisions.

The concept was first mentioned in “The Big Data Age” by Victor Meyer-Schoenberg. The authors argued that if “big data” data is comprehensive enough, through the analysis and mining techniques, we can rediscover the values of useless data, especially the value of data association, which cannot be obtained from the “small data”. Thus, logically, “big data” is completely different from the “small data”, and is complementary to “small data” in value.

The current Internet “big data” approach face the following main problems:

1. Big amount

1) Due to acquired rights to the data and the legal requirements, big data owners are only data managers, and really do not have permissions to use big data.

2) In theory, the analysis of big data is applied to the “all data”, but in fact big data has access to only part of the data. Really meaningful data is scattered in various independent systems, subject to confidentiality or personal privacy requirements by separate businesses and users, which is actually difficult to become the object of a big data analysis.

3) Internet of Things (public service data) or mobile Internet (mobile device/wearable equipment) is becoming major data sources of “big data”. Because the amount of data is not large enough and the limitations in the specific data format, it is still not possible to obtain more effective data by analysis.

2. Variety

1) Despite the large amount, some data in “big data” may not be relevant from the point of view of small data. It cannot be taken for granted that “big data” is more varied and diversified.

2) Although the “big data” is only relatively more diversified compared with the “small data”. Many of the data has inherent strong association and even causal relationship, but such relationships cannot be represented in “small data” due to the drawback in existing technical tools. As a compromise, they are guessed using big data.

Because the “big data” approach is “collect first, analyze later”, and the so-called “collection” activity is not during the data-generating event, but occurs after the event, so the data variety cannot be strengthened in the data production process. Therefore, the variety in big data is “uncontrollable”.

3. Value

1) Because the “big data” approach is “collect first, analyze later”, and the “collection” activity is not during the data-generating event, but occurs after the event, the value of big data can only be realized in the results of data analysis and data mining, and cannot be reflected in the data production process. Therefore, the value of big data is “uncontrollable”.

2) The source of big data is a large number of “small data” and the data production process of “small data” is not designed to achieve the application purpose of data analysis and data mining. Thus despite of the large volume in big data, its data lacks the causal relationship and the association relationship between many data, and thus has lost a lot of the data's inherent value.

3) The value of the data is finally achieved through analytical methods and mining models. Many of the data analysis and mining methods of big data occur after the data has been collected, which cannot intervene in data production processes and methods prior to or during data production, which also affects the “controllability” of values of big data.

4. Obstacles to increased application

1) Big data has a high technology threshold, which cannot be easily adopted by general businesses. It is difficult for the owners of data to extract values from big data on their own.

2) One of the core values of big data is the size of the data, and access to large amounts of data requires a large number of data sources. Thus it is difficult for a single enterprise or a group of enterprises to achieve the value of big data using their own data accumulation, which forms a huge obstacle for increased applications of big data.

3) Big number requires involvement of external professional companies. Many aspects of its value chain include technical conditions, expertise, data sources, application specifications, and so on. It is difficult to achieve results via local optimization.

In view of the above discussions, unsolved problems remain in data exchange and sharing between different data systems in the big data field, in order to reduce threshold of big data utilization, to determine the data association between different data systems, to analyze their associated model, and finally to enhance the value of the data.

### SUMMARY OF THE INVENTION

The purpose of the present invention is to overcome the above-mentioned disadvantages of the prior art, to provide an object data association index system based on datatag implementation and using object ID and associated matching operation ID, and the object small data generated by the operation, in order to solve the problems in conventional technologies. The disclosed system and methods effectively facilitate interactions and sharing of data between different data systems, thereby reducing the threshold for big data utilization, determine the data association between different data systems, analyze their associated model, and finally enhance the value of the data.

To achieve the above objects, the presently disclosed object data association index system can include a plurality of objects, an object small data server, and an object index data server.

Wherein, the plurality of objects can perform an operation and generate resulting data corresponding to the operation.

The object small data server can store object small data, wherein the object small data includes each of the plurality of objects and the associated resulting data.

The object small data is represented by an object ID and a corresponding operation ID, and matching relationship between corresponding resulting data.

The object ID is a unique identifier for identifying an object.

The operational ID is a uniform identifier in an operation performed by each of the plurality of objects.

The object index data server can acquire the object ID and the operation ID from the object small data server, and to generate and store object index data, the object index data being a collection of the object ID and the operation ID.

Implementations of the system may include one or more of the following. The object data association indexing system can further include a task server configured to issue tasks, wherein the plurality of objects acquire the tasks, and execute operations related to the tasks.

The task server can include a task generation module and a task issuing module, the task generation module that can generate a plurality of tasks, and the task issuing module configured to issue the plurality of tasks.

The task generation module can generate a first datatag, wherein the first datatag includes information about at least a first task. The plurality of objects can include a first object configured to acquire the first datatag and execute a first operation corresponding to the first task, and to generate a first resulting data. The object small data server can store a first object small data that includes a first object ID and a corresponding first operation ID, and matching relationship between the corresponding first resulting data.

The object index data server can store the object index data, the object index data comprising the first object ID and the first operation ID. The first object can generate a second datatag that includes the first task and/or the first resulting data.

The plurality of objects can include a second object configured to acquire the second datatag and execute a second operation corresponding to the first task, and to generate a second resulting data. The object small data server can store a second object index data that includes a second object ID and a corresponding second operation ID, and matching relationship between the corresponding second resulting data. The object index data server can store the second object index data, the second object index data comprising the second object ID and the second operation ID.

The object index data can further include a first task ID that matches the first object ID and the second object ID, wherein task IDs are unique identifiers for tasks issued by the task server.

The first object can acquire the first datatag using WiFi, an acoustic wave, an optical wave, or RFID. The first datatag can include a one dimensional datatag, a two dimensional datatag, a sound datatag, or a RFID tag.

The task generation module can generate an interactive task datatag, wherein the plurality of objects can execute interactive operations related to the interactive task datatag and generates interactive data corresponding to the interactive operations.

The object data association indexing system can further include a data interactive interface server that can interact with the object index data server and the object small data server, and to use the object index data, and based on the operational ID, to realize data interactions between resulting data generated by objects that have executed a same operation.

The object data association indexing system can further include an authentication service processor configured to authenticate the interactive task datatag to generate authentication result, and to control the data interactive interface server based on the authentication result.

The task issuing module can issue the association task datatag, wherein the plurality of objects execute association operations related to the association task datatag and generates association data corresponding to the interactive operations.

The object index data server can generate the object application data based on the object small data and the index application data, wherein the index application data includes the object index data and the corresponding object small data.

The object index data server can conduct association analysis on the object small data based on the index application data and the association data to generate association analysis data.

The task generation module can generate an association task datatag based on the correlation analysis result, wherein the object performs an association operation corresponding to the establishment of the association task and generates an association data corresponding to the operation.

The task issuing module can generate a retrieval task datatag, wherein one of the plurality of objects perform a retrieval operation corresponding to the retrieval task datatag, searches the index application data, and generates a retrieval result data.

The object index data server can model the object small data based on the index application data and the association data to generate an index application model corresponding to the index application data.

The object data association indexing system can further include a plurality of object small data servers, wherein each of the plurality of objects correspond to at least one of the plurality of object small data servers.

The plurality of objects include a mobile phone, a tablet computer, a smart wearable device, a personal computer, a cashier device, a ticket selling device, and a public display device.

A method for constructing an object data association indexing system can includes: (S200) conducting an operation a plurality of objects to generate resulting data corresponding to the operation; (S300) storing object small data by an object small data server, wherein the object small data includes each of the plurality of objects and the associated resulting data, wherein the object small data can be represented by an object ID and a corresponding operation ID, and matching relationship between corresponding resulting data; wherein the object ID is a unique identifier for identifying an object, wherein the operational ID is a uniform identifier in an operation performed by each of the plurality of objects; and (S400) acquiring the object ID and the operation ID by an object index data server from the object small data server, generating and storing object index data, wherein the object index data includes a collection of the object ID and the operation ID.

Implementations of the system may include one or more of the following. The method can further include (S100) issuing a task by a task server, wherein the (S200) step further comprises: acquiring the task by the object; executing an operation corresponding to the task, and generating resulting data corresponding to the operation.

The task server can include a task generation module and a task issuing module, wherein the (S100) step can further include: (S110) generating a plurality of tasks by the task generation module; and (S120) issuing the plurality of tasks by the task issuing module.

The (S110) step can further include: generating a first datatag by the task generation module, wherein the first datatag includes information about at least a first task, the plurality of objects include a first object, wherein the (S200) step can further include: (S210) acquiring the first datatag and executing a first operation corresponding to the first task, and to generate a first resulting data; wherein the (S300) step can further include: (S310) storing, by the object small data server, a first object small data that includes a first object ID and a corresponding first operation ID, and matching relationship between the corresponding first resulting data, wherein the (S300) step can further include: (S410) storing the object index data by the object index data server, the object index data comprising the first object ID and the first operation ID.

The (S200) step can further include: (S220) generating a second datatag by the first object, wherein the second datatag can include the first task and/or the first resulting data.

The plurality of objects can include a second object. The (S200) step can further include: (S230) acquiring the second datatag; and executing a second operation corresponding to the first task to generate a second resulting data; wherein the (S300) step can further include: (S320) storing a second object index data by the object small data server, wherein the second object index data can include a second object ID and a corresponding second operation ID, and matching relationship between the corresponding second resulting data, wherein the (S400) step can further include: (S420) storing the second object index data by the object index data server, wherein the second object index data can include the second object ID and the second operation ID.

The object index data can further include a first task ID that matches the first object ID and the second object ID, wherein task IDs are unique identifiers for tasks issued by the task server.

A method for the application of an object data association indexing system, wherein the object data association indexing system comprises a task server that issues tasks, wherein the plurality of objects acquire the tasks, and execute operations related to the tasks; an object small data server configured to store object small data, wherein the object small data can include each of the plurality of objects and the associated resulting data, wherein the object small data can be represented by an object ID and a corresponding operation ID, and matching relationship between corresponding resulting data, wherein the object ID is a unique identifier for identifying an object; wherein the operational ID is a uniform identifier in an operation performed by each of the plurality of objects; and an object index data server that can acquire the object ID and the operation ID from the object small data server, and to generate and store object index data, the object index data being a collection of the object ID and the operation ID, the method comprising: (A101) issuing the association task datatag by the task issuing module; and (A201) executing, by the plurality of objects, association operations related to the association task datatag and generates association data corresponding to the interactive operations.

Implementations of the system may include one or more of the following. The object data association indexing system further comprises a data interactive interface server configured to interact with the object index data server and the object small data server, the method further comprising: (A301) using the object index data, and based on the operational ID, to realize data interactions between resulting data generated by objects that have executed a same operation.

The object data association indexing system can further include an authentication service processor. The method can further include: (A102) authenticate the interactive task datatag to generate authentication result; and (A300) controlling the data interactive interface server based on the authentication result.

The method can further include: (A111) issuing the association task datatag by the task issuing module; and (A211) executing, by the plurality of objects, association operations related to the association task datatag and generates association data corresponding to the interactive operations.

The method can further include: (A401) generating the object application data by the object index data server based on the object small data and the index application data, wherein the index application data includes the object index data and the corresponding object small data.

The method can further include: (A402) conducting association analysis on the object small data by the object index data server based on the index application data and the association data to generate association analysis data.

The method can further include: (A501) generating an association task datatag by the task generation module based on the correlation analysis result; and (A502) performing, by the object, an association operation corresponding to the establishment of the association task and generates an association data corresponding to the operation.

The method can further include: (A601) generating a retrieval task datatag by the task issuing module; and (A602) performing a retrieval operation corresponding to the retrieval task datatag by one of the plurality of objects, searching the index application data, and generating a retrieval result data.

The method can further include: (A701) modeling the object small data by the object index data server based on the index application data and the association data to generate an index application model corresponding to the index application data.

The present disclosure relates to an object data association index system that includes a plurality of objects, an object small data server, and an object index data server. The object small data server stores the object small data. The object index data server obtains an object ID and an operation ID from the object small data server, generates and stores the object index data, thereby constructing the object ID and the associated operation ID and the object data association index between the small data generated by the operation. Different data systems can thus conveniently exchange and sharing data, which lowers utilization threshold for big data and assures data association between different data systems, allows analysis of data associated model, which ultimately enhances data value.

### BRIEF DESCRIPTION OF THE DRAWINGS

FIG. 1 is an exemplified schematic diagram for the ID system implemented by the object data association index system and associated construction method in accordance with some embodiments of the present invention.

FIG. 2 is an exemplified schematic diagram illustrating a method for data exchanges between systems implemented by the object data association index system and associated application methods in accordance with some embodiments of the present invention.

FIG. 3 is an exemplified schematic diagram illustrating another method for data exchanges between systems implemented by the object data association index system and associated application methods in accordance with some embodiments of the present invention.

### DETAILED DESCRIPTION OF THE INVENTION

The disclosed invention can be more clearly understood with the following detailed descriptions of the following examples.

In some embodiments, the object data association index system that includes a plurality of objects, an object small data server, and an object index data server.

Wherein, the plurality of objects can perform an operation and generate resulting data corresponding to the operation.

The object small data server can store object small data, wherein the object small data includes each of the plurality of objects and the associated resulting data.

The object small data is represented by an object ID and a corresponding operation ID, and matching relationship between corresponding resulting data.

The object ID is a unique identifier for identifying an object.

The operational ID is a uniform identifier in an operation performed by each of the plurality of objects.

The object index data server can acquire the object ID and the operation ID from the object small data server, and to generate and store object index data, the object index data being a collection of the object ID and the operation ID.

A method for constructing an object data association indexing system can includes:

(S200) conducting an operation a plurality of objects to generate resulting data corresponding to the operation;

(S300) storing object small data by an object small data server, wherein the object small data includes each of the plurality of objects and the associated resulting data, wherein the object small data can be represented by an object ID and a corresponding operation ID, and matching relationship between corresponding resulting data; wherein the object ID is a unique identifier for identifying an object, wherein the operational ID is a uniform identifier in an operation performed by each of the plurality of objects; and

(S400) acquiring the object ID and the operation ID by an object index data server from the object small data server, generating and storing object index data, wherein the object index data includes a collection of the object ID and the operation ID.

The method for constructing an object data association indexing system can further include the following steps:

(S100) issuing a task by a task server,

wherein the (S200) step further comprises: acquiring the task by the object;

executing an operation corresponding to the task, and generating resulting data corresponding to the operation.

The task server can include a task generation module and a task issuing module,

wherein the (S100) step can further include:

(S110) generating a plurality of tasks by the task generation module; and

(S120) issuing the plurality of tasks by the task issuing module.

In some embodiments, the task generation module can generate a first datatag, wherein the first datatag includes information about at least a first task. The plurality of objects can include a first object configured to acquire the first datatag and execute a first operation corresponding to the first task, and to generate a first resulting data. The object small data server can store a first object small data that includes a first object ID and a corresponding first operation ID, and matching relationship between the corresponding first resulting data.

In the method for constructing an object data association indexing system, the (S110) step can further include: generating a first datatag by the task generation module,

wherein the first datatag includes information about at least a first task, the plurality of objects include a first object, wherein the (S200) step can further include:

(S210) acquiring the first datatag and executing a first operation corresponding to the first task, and to generate a first resulting data;

wherein the (S300) step can further include:

(S310) storing, by the object small data server, a first object small data that includes a first object ID and a corresponding first operation ID, and matching relationship between the corresponding first resulting data,

wherein the (S300) step can further include:

(S410) storing the object index data by the object index data server, the object index data comprising the first object ID and the first operation ID.

In some embodiments, the first object can generate a second datatag that includes the first task and/or the first resulting data.

The (S200) step can further include:

(S220) generating a second datatag by the first object, wherein the second datatag can include the first task and/or the first resulting data.

In some embodiments, the plurality of objects can include a second object configured to acquire the second datatag and execute a second operation corresponding to the first task, and to generate a second resulting data. The object small data server can store a second object index data that includes a second object ID and a corresponding second operation ID, and matching relationship between the corresponding second resulting data. The object index data server can store the second object index data, the second object index data comprising the second object ID and the second operation ID.

The (S200) step can further include: (S230) acquiring the second datatag; and executing a second operation corresponding to the first task to generate a second resulting data; wherein the (S300) step can further include: (S320) storing a second object index data by the object small data server, wherein the second object index data can include a second object ID and a corresponding second operation ID, and matching relationship between the corresponding second resulting data, wherein the (S400) step can further include: (S420) storing the second object index data by the object index data server, wherein the second object index data can include the second object ID and the second operation ID.

In some embodiments, the object index data can further include a first task ID that matches the first object ID and the second object ID, wherein task IDs are unique identifiers for tasks issued by the task server.

In the method for constructing the object data association indexing system, the object index data further includes a first task ID that matches the first object ID and the second object ID, wherein task IDs are unique identifiers for tasks issued by the task server.

In some embodiments, the first object can acquire the first datatag using WiFi, an acoustic wave, an optical wave, or RFID. The first datatag can include a one dimensional datatag, a two dimensional datatag, a sound datatag, or a RFID tag.

In some embodiments, the task generation module can generate an interactive task datatag, wherein the plurality of objects can execute interactive operations related to the interactive task datatag and generates interactive data corresponding to the interactive operations.

A method for the application of an object data association indexing system, wherein the object data association indexing system comprises a task server that issues tasks, wherein the plurality of objects acquire the tasks, and execute operations related to the tasks;

an object small data server configured to store object small data, wherein the object small data can include each of the plurality of objects and the associated resulting data,

wherein the object small data can be represented by an object ID and a corresponding operation ID, and matching relationship between corresponding resulting data,

wherein the object ID is a unique identifier for identifying an object; wherein the operational ID is a uniform identifier in an operation performed by each of the plurality of objects; and

an object index data server that can acquire the object ID and the operation ID from the object small data server, and to generate and store object index data, the object index data being a collection of the object ID and the operation ID.

The method for the application of the object data association indexing system can include:

(A101) issuing the association task datatag by the task issuing module; and

(A201) executing, by the plurality of objects, association operations related to the association task datatag and generates association data corresponding to the interactive operations.

Implementations of the system may include one or more of the following. The object data association indexing system further comprises a data interactive interface server configured to interact with the object index data server and the object small data server.

The method for the application of the object data association indexing system can further include:

(A301) using the object index data, and based on the operational ID, to realize data interactions between resulting data generated by objects that have executed a same operation.

The object data association indexing system can further include an authentication service processor.

The method for the application of the object data association indexing system can further include:

(A102) authenticate the interactive task datatag to generate authentication result; and

(A300) controlling the data interactive interface server based on the authentication result.

The method for the application of the object data association indexing system can further include:

(A111) issuing the association task datatag by the task issuing module; and

(A211) executing, by the plurality of objects, association operations related to the association task datatag and generates association data corresponding to the interactive operations.

The method for the application of the object data association indexing system can further include:

(A401) generating the object application data by the object index data server based on the object small data and the index application data, wherein the index application data includes the object index data and the corresponding object small data.

The method for the application of the object data association indexing system can further include:

(A402) conducting association analysis on the object small data by the object index data server based on the index application data and the association data to generate association analysis data.

The method for the application of the object data association indexing system can further include:

(A501) generating an association task datatag by the task generation module based on the correlation analysis result; and

(A502) performing, by the object, an association operation corresponding to the establishment of the association task and generates an association data corresponding to the operation.

The method for the application of the object data association indexing system can further include:

(A601) generating a retrieval task datatag by the task issuing module; and

(A602) performing a retrieval operation corresponding to the retrieval task datatag by one of the plurality of objects, searching the index application data, and generating a retrieval result data.

The method for the application of the object data association indexing system can further include:

(A701) modeling the object small data by the object index data server based on the index application data and the association data to generate an index application model corresponding to the index application data.

In some embodiments, the object data association indexing system can further include a plurality of object small data servers, wherein each of the plurality of objects correspond to at least one of the plurality of object small data servers.

In some embodiments, the plurality of objects can include a mobile phone, a tablet computer, a smart wearable device, a personal computer, a cashier device, a ticket selling device, and a public display device.

In the practical application, the presently disclosed object data association indexing system can be understood as an object data indexing method (ODIM), which is a method for production/acquisition/storage/management/collection/retrieval/sharing of object data and for controlling the optimization of the sensor network and data utilization in its data production process.

ODIM is based on the conviction that both the real world and the virtual world, “behavior” constitutes the basic unit of all activities, and is also the main source for producing “small data”, which is also the media for data exchange between “small data” and for causal relationship and association relationship between “small data”.

ODIM defines “behavior” as “object”, which utilizes the technical methods and service system of OTO (Object to Object) to provide an object data indexing method for the behavior (object), indexing (attribution, aggregating), causal relationship/association relationship of data.

The data produced by the ODIM method is called index application data, or ODID (Object Data Indexing Data), which is composed of OID (Object Indexing Data) and OSD (object small data) produced by ODIM method.

ODID is a collection of structured or semi-structured “small data” with causality and association relationships. It has data accuracy, and also has large quantity, diversity and value attribute.

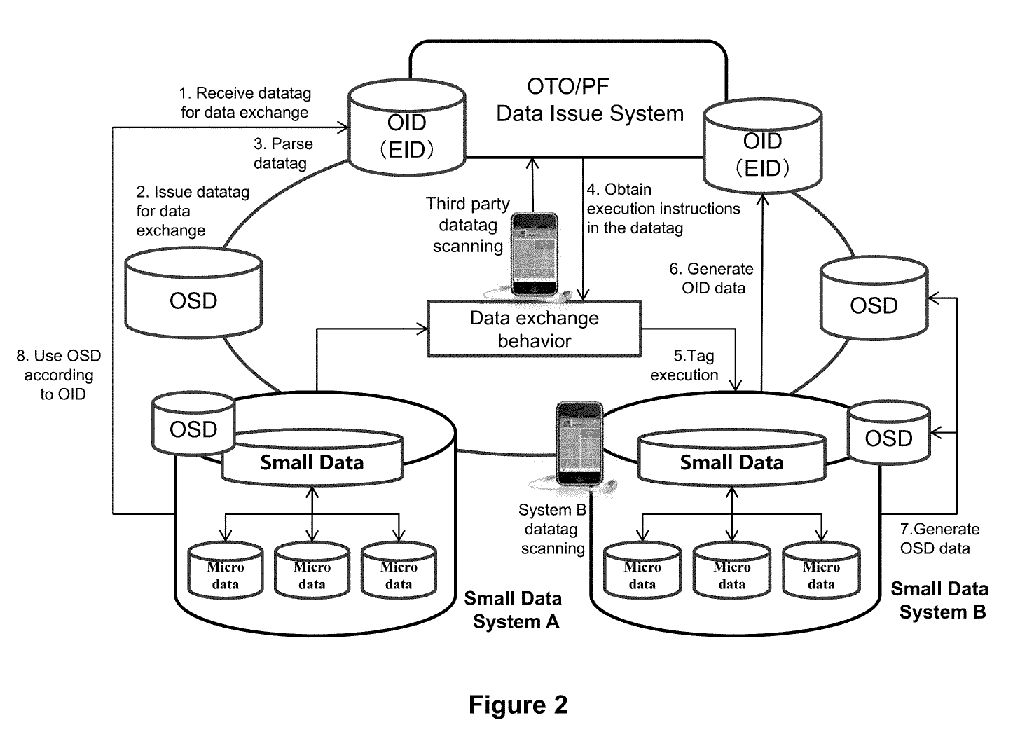

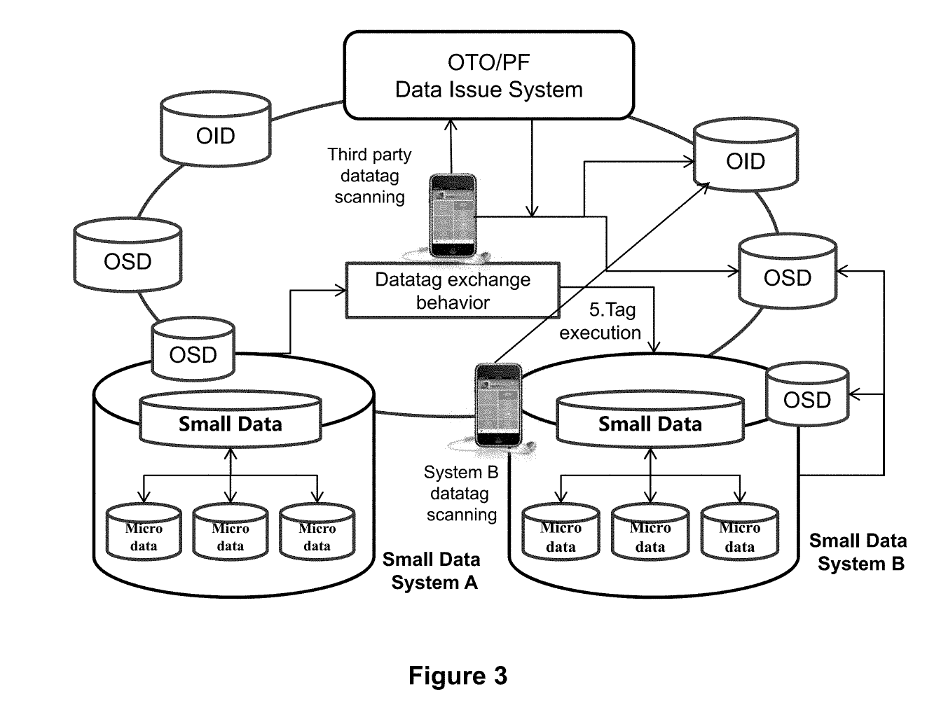

The basic approach of ODIM and the method of achieving data interactions between different systems in the disclosed system are shown in FIGS. 2 and 3, and include the following,

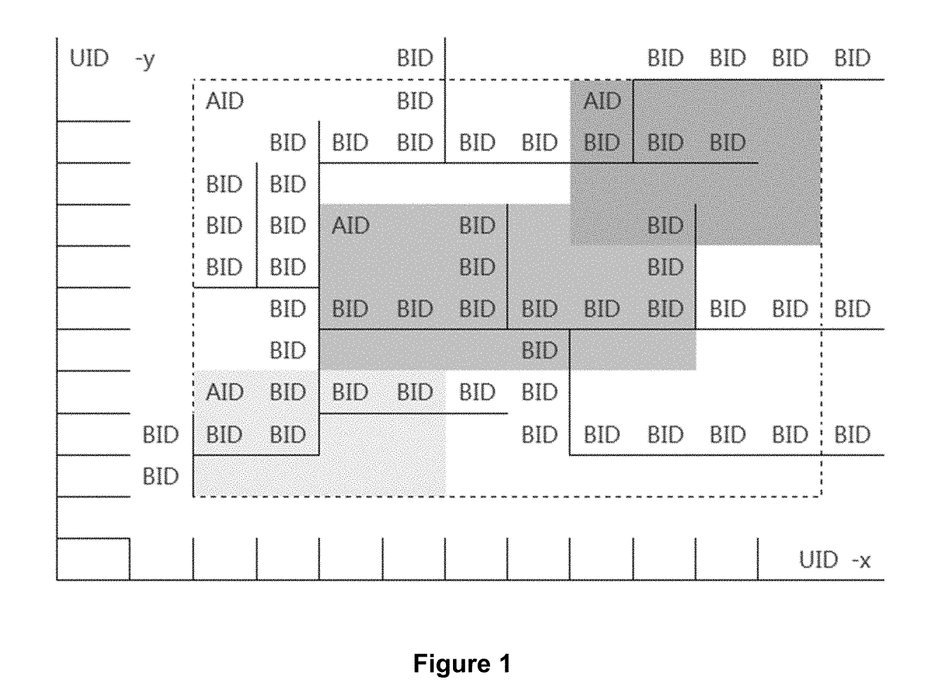

1. The establishment of ID system as shown in FIG. 1. Wherein UID (Object ID) is a globally unique ID (object ID) assigned to a single Object, BID (Behavior ID or Behavior Index) is a behavioral relationship index assigned to each causal relationship, and AID (Activity/Task ID, Index) is an index assigned to the activity/task (process).

2. The establishment of IDS (ID Certification Service Center)

IDS issues, authenticates, and manages UID, BID, and AID.

3. Defining “behavior (operation)”

Define UID as the attribute of “behavior”.

4. Defining “behavior” ID (BID, operation ID).

5. Defining “activities/tasks”.

Using datatags to define “activities/tasks”, and the results and scope of “activities/tasks” and associated rights in the collaboration contract.

6. Defining the “activity/task (process)” ID (Activity/Task ID)

7. Defining OID (Object Index Data) as a collection of UID and BID

8. Defining OSD (Object Small Data) as a “small data” (an operation or a set of operations) corresponding to UID and BID.

AID (task ID) is the range of the corresponding OID-OSD “small data” cluster (start/end of activity/task).

9. The establishment of IFS (interface service)

IFS is an interface compatible with OTO that exists in OTO devices.

10. The establishment of Scanning Device Network (perception network) for Data Label (DL or datatag), through scanning, WiFi, sound waves, optical waves, RFID, and other Internet of things sensing method, perception DL.

11. The establishment of DL implementation method

The OTO DL is executed by the cooperation of IDS and IFS.

12. The production ODID or the retrieval of the application data. By implementation of DL, ODID is produced according to the purpose of application/results. ODID is composed of by OID.

13. ODID storage and management

(1) Establishing tasks for management applications to obtain AID (OTO application services).

(2) Establishing the scope/privilege of AID, to set up an OID database (including associated UID, BID).

(3) Establishing the correspondence between OID and OSD (OTO Public Service IDS).

(4) Establishing OID as the index database (OTO application services) in the OSD.

14. ODID collection

(1) Data collection methods (including mandatory/free, passive/active data collection models).

(2) Collect data through DL.

15. ODID search

Obtaining causal or correlation relationships between data and related OSD by indexing UID, BID in ODID within the scope of AID.

16. ODID use

(1) Establishing use models (MLM, etc.).

(2) Collecting relevant ODID.

(3) Retrieving ODID.

(4) Utilizing ODID according to the use model.

17. Establishing data association

(1) Setting task in association relationships.

(2) Issuing production tasks (AID) for associated data.

(3) Setting associated data collection behavior as DL

(4) Implementing DL to generate the acquisition behavior BID for the associated data and the corresponding OSD.

(5) Using ODID for correlation analysis.

18. The control of data production methods and optimization

(1) Setting production tasks in data collection.

(2) Issuing production tasks in data collection (AID).

(3) Setting acquisition data behavior DL.

(4) Implementing DL to generate acquisition data behavior BID and the corresponding OSD.

(5) Using the collected ODID.

(6) Optimizing data acquisition collaboration DL based on the collected data production task.

The values of the index application data ODID include:

First, according to the purpose of setting up data production, collection, management, retrieval, use of the task

1) The increase or decrease in attribute (UID)

2) The increase or decrease in behavior (BID)

3) The increase or decrease in scope and authority (AID)

4) Updating the data label (DL)

Second, obtaining association and causal data purposely through the ODID.

Third, increasing the scope of the data (in theory, all OSD collections can be used).

Fourth, increasing OID on the basis of the OSD.

Fifth, greatly increasing the diversity and value of data using OID as index and retrieval conditions for OSD data.

Sixth, by increasing the behavior DL, purposely increasing the scope of data collection, attributes, and relevance.

Seventh, data collection method ensures data ownership and use authority.

Eighth, OID manages data indexing respectively according to UID, BID, AID. OSD stores application services in respective OTO. The integrity of ODID can only kept when OID and OSD are obtained at the same time, thereby greatly enhancing ODID data security and privacy.

Implementation Example 1. Applications in EDI electronic data exchange

Master: Using ID management of OTO, it is possible to standardize the common master data of EDI data transmission, which makes EDI data easy to analyze and reduce the extra burden in the system I/F due to format conversion, and thus improves processing efficiency.

Querying and Analyze: through OTO's small data fragmentation, a cross-platform can be constructed for cross-system EDI data interactions, and to avoid complex data synchronization and interface due to data redundancy. Case study: a conventional personal credit system needs to connect personal data, criminal records, bank credit and other non-affiliated databases, using traditional EDI interfaces to connect to each database that may be scattered in different geographical or administrative regions. In contrast, a unique UID used in OTO, which allows immediate or asynchronous access to these personal information.

Proxy service: through OTO application management, each of the systems can find and access interactive objects (system) of the EDI data via OTO, making it possible to use EDI data proxy service. Case study: system A needs to exchange EDI data with system B, but data in system B is too complex and difficult to debug. So a system C that is familiar with company B provides a set of OTO-based data agent service system. System A and system C connect to accomplish EDI data exchange with system B. In addition, proxy services can also integrate multiple OTO applications to provide integrated data services for other applications. For example, insurance data service agents can integrate data services for multiple insurance companies, to provide paid data analysis services for the industry.

IFS role: standardize OTO EDI data service interface for safe and efficient data transmission.

Implementation Example 2. Commercial application (tourism)

Tour package information, scenic information, local products and local services can produce relevant data labels (DL) through the OTO platform (Generate/Define/Publish AID) through.

Online/offline information can be exchanged as datatags or data labels DL on the OTO platform.

Multimedia/advertisement information can be embedded in audio data label.

Mobile/fixed WiFi access can be embedded into datatags.

The user terminal senses the data label through an intelligent terminal App, obtains information about tourism activity, and carries on the related operation (produces the BID).

Implementation Example 3. Electronic money transaction

When the electronic money transaction is carried out using a network, it can be implemented using the disclosed object data association index system and its application method. That is, the electronic money transaction is treated as an “operation” in the object index data association system. When a user completes an electronic money transaction, a new datatag is generated, which is equivalent to generating a data packet (i.e. a “block”) having the electronic money transaction information. The corresponding transaction information is stored as the corresponding object small data. When the electronic money carries on the follow-up transaction, the disclose system and methods can provide the record of the pre-order transaction. The relevant transaction records are separately stored in the different object small data servers. Thus the data storage can be effectively decentralized, and the security of electronic money transactions is ensured at the data level.

The disclosed object data association index system includes a plurality of objects, an object small data server, and an object index data server. The object small data server stores the object small data. The object index data server obtains an object ID and an operation ID from the object small data server, generates and stores the object index data, thereby constructing the object ID and the associated operation ID and the object data association index between the small data generated by the operation. Different data systems can thus conveniently exchange and sharing data, which lowers utilization threshold for big data and assures data association between different data systems, allows analysis of data associated model, which ultimately enhances data value.

In the present specification, the present invention has been described with specific examples. However, it should be noted that various modifications and variations may be made without departing from the spirit and scope of the invention. Accordingly, the specification and drawings are to be regarded for illustrative rather than restrictive purposes.

What is claimed is:

1. An object data association indexing system, comprising:
a plurality of objects configured to perform an operation and generate resulting data corresponding to the operation;
an object small data server configured to store object small data, wherein the object small data includes each of the plurality of objects and the associated resulting data, wherein the object small data is represented by an object ID and a corresponding operation ID, and matching relationship between corresponding resulting data,
wherein the object ID is a unique identifier for identifying an object,
wherein the operational ID is a uniform identifier in an operation performed by each of the plurality of objects; and
an object index data server configured to acquire the object ID and the operation ID from the object small data server, and to generate and store object index data, the object index data being a collection of the object ID and the operation ID.

2. The object data association indexing system of claim 1, further comprising:
a task server configured to issue tasks, wherein the plurality of objects acquire the tasks, and execute operations related to the tasks.

3. The object data association indexing system of claim 2, wherein the task server comprises a task generation module and a task issuing module, the task generation module configured to generate a plurality of tasks, and the task issuing module configured to issue the plurality of tasks.

4. The object data association indexing system of claim 3, wherein the task generation module is configured to generate a first datatag, wherein the first datatag includes information about at least a first task,
wherein the plurality of objects include a first object configured to acquire the first datatag and execute a first operation corresponding to the first task, and to generate a first resulting data,
wherein the object small data server stores a first object small data that includes a first object ID and a corresponding first operation ID, and matching relationship between the corresponding first resulting data,
wherein the object index data server stores the object index data, the object index data comprising the first object ID and the first operation ID.

5. The object data association indexing system of claim 4, wherein the first object is configured to generate a second datatag that includes the first task and/or the first resulting data.

6. The object data association indexing system of claim 5, wherein the plurality of objects include a second object configured to acquire the second datatag and execute a second operation corresponding to the first task, and to generate a second resulting data,
wherein the object small data server stores a second object index data that includes a second object ID and a corresponding second operation ID, and matching relationship between the corresponding second resulting data,
wherein the object index data server stores the second object index data, the second object index data comprising the second object ID and the second operation ID.

7. The object data association indexing system of claim 6, wherein the object index data further includes a first task ID that matches the first object ID and the second object ID, wherein task IDs are unique identifiers for tasks issued by the task server.

8. The object data association indexing system of claim 6, wherein the first object acquires the first datatag using WiFi, an acoustic wave, an optical wave, or RFID.

9. The object data association indexing system of claim 8, wherein the first datatag includes a one dimensional datatag, a two dimensional datatag, a sound datatag, or a RFID tag.

10. The object data association indexing system of claim 3, wherein the task generation module is configured to generate an interactive task datatag, wherein the plurality of objects execute interactive operations related to the interactive task datatag and generates interactive data corresponding to the interactive operations.

11. The object data association indexing system of claim 10, further comprising:
a data interactive interface server configured to interact with the object index data server and the object small data server, and to use the object index data, and based on the operational ID, to realize data interactions between resulting data generated by objects that have executed a same operation.

12. The object data association indexing system of claim 11, further comprising:
an authentication service processor configured to authenticate the interactive task datatag to generate authentication result, and to control the data interactive interface server based on the authentication result.

13. The object data association indexing system of claim 10, wherein the task issuing module is configured to issue the association task datatag, wherein the plurality of objects execute association operations related to the association task datatag and generates association data corresponding to the interactive operations.

14. The object data association indexing system of claim 13, wherein the object index data server is configured to generate the object application data based on the object small data and the index application data, wherein the index application data includes the object index data and the corresponding object small data.

15. The object data association indexing system of claim 14, wherein the object index data server is configured to conduct association analysis on the object small data based on the index application data and the association data to generate association analysis data.

16. The object data association indexing system of claim 15, wherein the task generation module is configured to generate an association task datatag based on the correlation analysis result, wherein the object performs an association operation corresponding to the establishment of the association task and generates an association data corresponding to the operation.

17. The object data association indexing system of claim 14, wherein the task issuing module is configured to generate a retrieval task datatag, wherein one of the plurality of objects perform a retrieval operation corresponding to the retrieval task datatag, searches the index application data, and generates a retrieval result data.

18. The object data association indexing system of claim 14, wherein the object index data server is configured to model the object small data based on the index application data and the association data to generate an index application model corresponding to the index application data.

19. The object data association indexing system of claim 1, further comprising:
a plurality of object small data servers, wherein each of the plurality of objects correspond to at least one of the plurality of object small data servers.

20. The object data association indexing system of claim 1, wherein the plurality of objects include a mobile phone, a tablet computer, a smart wearable device, a personal computer, a cashier device, a ticket selling device, and a public display device.

21. A method for constructing an object data association indexing system, comprising:
(S200) conducting an operation a plurality of objects to generate resulting data corresponding to the operation;
(S300) storing object small data by an object small data server, wherein the object small data includes each of the plurality of objects and the associated resulting data, wherein the object small data is represented by an object ID and a corresponding operation ID, and matching relationship between corresponding resulting data,
wherein the object ID is a unique identifier for identifying an object,
wherein the operational ID is a uniform identifier in an operation performed by each of the plurality of objects; and
(S400) acquiring the object ID and the operation ID by an object index data server from the object small data server, generating and storing object index data, wherein the object index data includes a collection of the object ID and the operation ID.

22. The method of claim 21, further comprising:
(S100) issuing a task by a task server,
wherein the (S200) step further comprises:
acquiring the task by the object;
executing an operation corresponding to the task; and
generating resulting data corresponding to the operation.

23. The method of claim 22, wherein the task server comprises a task generation module and a task issuing module,
wherein the (S100) step further comprises:
(S110) generating a plurality of tasks by the task generation module; and
(S120) issuing the plurality of tasks by the task issuing module.

24. The method of claim 23, wherein the (S110) step further comprises:
generating a first datatag by the task generation module, wherein the first datatag includes information about at least a first task,
wherein the plurality of objects include a first object, wherein the (S200) step further comprises:
(S210) acquiring the first datatag and executing a first operation corresponding to the first task, and to generate a first resulting data;
wherein the (S300) step further comprises:
(S310) storing, by the object small data server, a first object small data that includes a first object ID and a corresponding first operation ID, and matching relationship between the corresponding first resulting data,
wherein the (S300) step further comprises:
(S410) storing the object index data by the object index data server, the object index data comprising the first object ID and the first operation ID.

25. The method of claim 24, wherein the (S200) step further comprises:
(S220) generating a second datatag by the first object, wherein the second datatag includes the first task and/or the first resulting data.

26. The method of claim 25, wherein the plurality of objects include a second object, wherein the (S200) step further comprises:
(S230) acquiring the second datatag; and
executing a second operation corresponding to the first task to generate a second resulting data,
wherein the (S300) step further comprises:
(S320) storing a second object index data by the object small data server, wherein the second object index data includes a second object ID and a corresponding second operation ID, and matching relationship between the corresponding second resulting data,
wherein the (S400) step further comprises:
(S420) storing the second object index data by the object index data server, wherein the second object index data comprises the second object ID and the second operation ID.

27. The method of claim 26, wherein the object index data further includes a first task ID that matches the first object ID and the second object ID, wherein task IDs are unique identifiers for tasks issued by the task server.

28. A method for the application of an object data association indexing system, wherein the object data association indexing system comprises:
a task server configured to issue tasks, wherein the plurality of objects acquire the tasks, and execute operations related to the tasks;
an object small data server configured to store object small data, wherein the object small data includes each of the plurality of objects and the associated resulting data, wherein the object small data is represented by an object ID and a corresponding operation ID, and matching relationship between corresponding resulting data,
wherein the object ID is a unique identifier for identifying an object,
wherein the operational ID is a uniform identifier in an operation performed by each of the plurality of objects; and
an object index data server configured to acquire the object ID and the operation ID from the object small data server, and to generate and store object index data, the object index data being a collection of the object ID and the operation ID,
the method comprising:
(A101) issuing the association task datatag by the task issuing module; and
(A201) executing, by the plurality of objects, association operations related to the association task datatag and generates association data corresponding to the interactive operations.

29. The method of claim 28, wherein the object data association indexing system further comprises a data interactive interface server configured to interact with the object index data server and the object small data server, the method further comprising:
(A301) using the object index data, and based on the operational ID, to realize data interactions between resulting data generated by objects that have executed a same operation.

30. The method of claim 29, wherein the object data association indexing system further comprises an authentication service processor, the method further comprising:
(A102) authenticate the interactive task datatag to generate authentication result; and
(A300) controlling the data interactive interface server based on the authentication result.

31. The method of claim 28, further comprising:
(A111) issuing the association task datatag by the task issuing module; and
(A211) executing, by the plurality of objects, association operations related to the association task datatag and generates association data corresponding to the interactive operations.

32. The method of claim 31, further comprising:
(A401) generating the object application data by the object index data server based on the object small data and the index application data, wherein the index application data includes the object index data and the corresponding object small data.

33. The method of claim 32, further comprising:
(A402) conducting association analysis on the object small data by the object index data server based on the index application data and the association data to generate association analysis data.

34. The method of claim 33, further comprising:
(A501) generating an association task datatag by the task generation module based on the correlation analysis result; and
(A502) performing, by the object, an association operation corresponding to the establishment of the association task and generates an association data corresponding to the operation.

35. The method of claim 34, further comprising:
(A601) generating a retrieval task datatag by the task issuing module; and
(A602) performing a retrieval operation corresponding to the retrieval task datatag by one of the plurality of objects, searching the index application data, and generating a retrieval result data.

36. The method of claim 34, further comprising:
(A701) modeling the object small data by the object index data server based on the index application data and the association data to generate an index application model corresponding to the index application data.
